(19) United States
(12) Patent Application Publication
(10) Pub. No.: US 2012/0314694 A1
(43) Pub. Date: Dec. 13, 2012

(54) Method of Back-off Procedure Setup in a Wireless Communication System

(76) Inventor: Jing-Rong Hsieh, Taoyuan County (TW)

(21) Appl. No.: 13/491,565

(22) Filed: Jun. 7, 2012

Related U.S. Application Data
(60) Provisional application No. 61/493,987, filed on Jun. 7, 2011.

(51) Int. Cl. H04W 74/00; H04W 84/12

(52) U.S. Cl. 370/338

(57) ABSTRACT

A method of back-off procedure setup in a wireless communication system, comprising initiating an enhanced distributed channel access (EDCA) transmit opportunity (TXOP) for transmission by a primary access category (AC), sharing the EDCA TXOP with at least a secondary AC, determining whether an initial frame of the primary AC is successfully transmitted, determining whether one or more frames of one of the at least a secondary AC are successfully transmitted during the EDCA TXOP, determining whether to invoke a point coordination function inter-frame space (PIFS) recovery procedure for the secondary AC if the one or more frames of the secondary AC are not successfully transmitted during the EDCA TXOP, setting a contention window of the secondary AC by an enhanced distributed channel access function (EDCAF) of the secondary AC, and setting a back-off timer of the secondary AC after the end of the EDCA TXOP.

### CROSS REFERENCE TO RELATED APPLICATIONS

This application claims the benefit of U.S. Provisional Application No. 61/493,987 filed on Jun. 7, 2011 and entitled “Methods of backoff value adjustment for MU-MIMO TXOP in wireless communications systems”, the contents of which are incorporated herein.

### BACKGROUND OF THE INVENTION

1. Field of the Invention

The invention relates to a method of back-off procedure setup in a wireless communication system, and more particularly, to a method of back-off procedure setup of all access categories participating in MU-MIMO transmissions in a wireless communication system.

2. Description of the Prior Art

Multiple-input-multiple-output (MIMO) technology has the abilities of increasing data throughput and link range without additional bandwidth or increased transmit power, such that modern radio technologies, including the Wireless Local Area Network (WLAN), the Long-Term Evolution (LTE) and the Worldwide Interoperability for Microwave Access (WiMAX) adopt the MIMO technology into specification/standard thereof. For WLAN, multi-user MIMO (MU-MIMO) technology is newly introduced and supports multiple users to access the wireless medium utilizing MIMO communications simultaneously. However, to achieve fairness while maintaining prioritized channel access in the contention based WLAN access scheme, the back-off procedure is an important task for an access category (AC) participating a MU-MIMO transmission and it is not defined in previous single-user MIMO (SU-MIMO) transmission of a WLAN system.

### SUMMARY OF THE INVENTION

It is therefore a primary objective of the present invention to provide a method of back-off procedure setup for MU-MIMO transmission with fairness and provision of quality of service (QoS).

The present invention discloses a method of back-off procedure setup in a wireless communication system, comprising initiating an enhanced distributed channel access (EDCA) transmit opportunity (TXOP) for transmission by a primary access category (AC); sharing the EDCA TXOP with at least a secondary AC by including traffics from the at least a secondary AC in one or more multi-user physical layer protocol data units (MU-PPDUs); determining whether an initial frame of the primary AC is successfully transmitted; determining whether one or more frames of one of the at least a secondary AC are successfully transmitted during the EDCA TXOP; determining whether to invoke a point coordination function inter-frame space (PIFS) recovery procedure for the secondary AC if the one or more frames of the secondary AC are not successfully transmitted during the EDCA TXOP; setting a contention window of the secondary AC by an enhanced distributed channel access function (EDCAF) of the secondary AC; and setting a back-off timer of the secondary AC after the end of the EDCA TXOP.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to the present invention.

FIG. 2 is a schematic diagram of an exemplary communication device of the present invention.

FIG. 3 is a structure diagram of the wireless access point in FIG. 1.

FIGS. 4A-4B are diagrams showing TXOP sharing during an EDCA TXOP.

FIG. 5 is a flowchart diagram showing a back-off procedure setup process according to the present invention.

FIG. 6 is a flowchart diagram showing contention window setup for a secondary AC according to the present invention.

### DETAILED DESCRIPTION

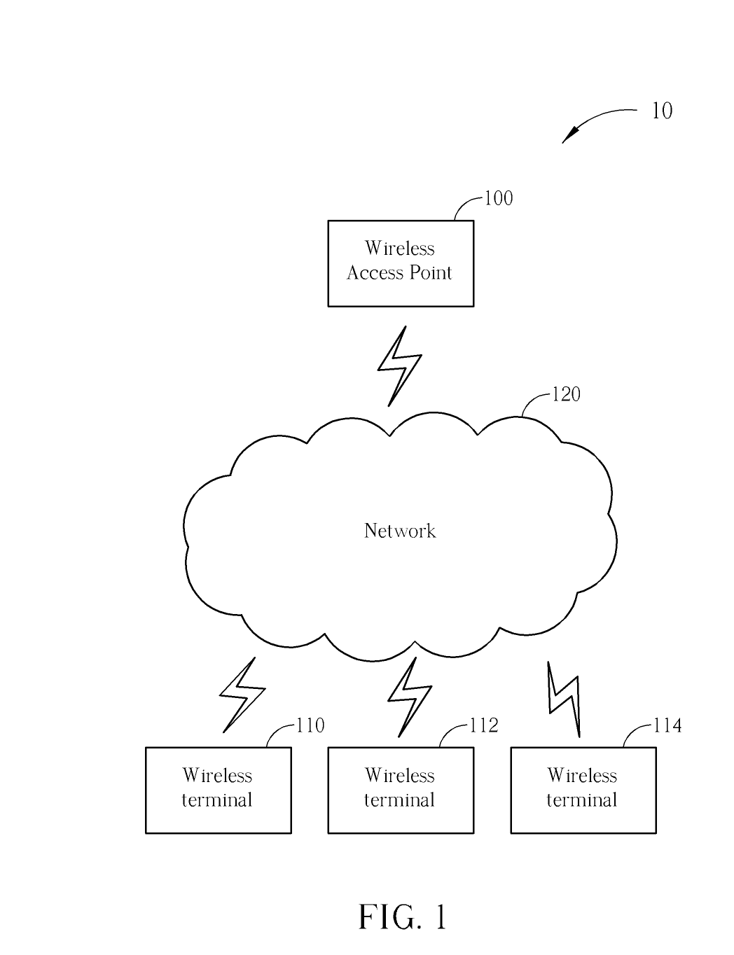

Please refer to FIG. 1, which is a schematic diagram of a wireless communication system 10 according to an example of the present invention. The wireless communication system 10 includes a wireless access point 100 and at least one wireless terminal such as the wireless terminals 110, 112 and 114. In the wireless communication system 10, the wireless access point 100 and the wireless terminals 110, 112, 114 perform wireless communication through the network 120. The wireless communication system 10, the wireless access point 100, the wireless terminals 110, 112, 114 and the network 120 comply with a variety of WLAN standards such as IEEE 802.11 standards and support multi-user multiple-input-multiple-output (MU-MIMO) technique, which can be adopted to utilize the spatial degrees of freedom by transmitting physical layer protocol data units (PPDUs) to the wireless terminals 110, 112 and 114 simultaneously.

For example, the IEEE 802.11e standard, which is specified by the IEEE 802.11 standard working group, supports quality of service (QoS) by providing differentiated services according to access categories (ACs). The ACs in the IEEE 802.11 standard are defined for four categories: AC_VO for voice traffic, AC_VI for video traffic, AC_BE for best effort traffic, and AC_BE for background traffic. The priority ordering of the four ACs is AC_VI>AC_VO>AC_BE>AC_BK. Each AC is mapped to an enhanced distributed channel access function (EDCAF), which behaves as a single contention entity for obtaining an enhanced distributed channel access (EDCA) transmit opportunity (TXOP) to have the right to access the medium in the period of EDCA TXOP. The EDCA TXOP is a time interval during which an application with a specific access category has the priority to initiate transmission. The application may transmit multiple frames if the EDCA TXOP allows.

The EDCAFs of different ACs compete for access to the medium by deferring for a fixed period, the arbitration inter-frame space (AIFS), when the medium becomes idle and then for a random back-off period drawn from a uniform distribution over the interval between zero and the contention window, which represents an integer value within the range of values related to physical layer characteristics aCWmin and aCWmax. For example, depending on AC, the value of the minimum contention window may be set to be aCWmin or half of aCWmin.

Three modes for an EDCA TXOP are defined, which includes the initiation of the EDCA TXOP, the sharing of the EDCA TXOP, and the multiple frame transmission within the EDCA TXOP. The initiation of the EDCA TXOP occurs when the EDCA rules permit access of an EDCAF to the medium. The sharing of the EDCA TXOP occurs when an EDCAF has obtained access to the medium, making its associated AC as the primary AC, and shares access with EDCAFs associated with other ACs during MU PPDU transmission. Other than the primary AC, the ACs joining the MU TXOP are called secondary ACs. The multiple-frame transmission within the EDCA TXOP occurs when an EDCAF retains the right to access the medium following the completion of a frame exchange sequence, such as one receipt of an ACK frame.

As mentioned above, the EDCAF that is granted an EDCA TXOP may share the EDCA TXOP with other EDCAFs which did not win in the contention of the medium access. Other ACs with pending frames in the queues and participating in the EDCA TXOP become secondary ACs and their corresponding destinations become secondary destinations. The AP groups the eligible secondary destinations together with the primary destination(s) for simultaneous transmissions. When sharing, an EDCAF of secondary AC may start to transmit even though it has not won channel access contention and with nonzero or zero back-off timer. For the zero back-off timer case, the EDCA MU-XOP is granted to the AC with higher priority.

During the period of the EDCA TXOP won by an EDCAF, the wireless access point 100 may initiate multiple frame exchange sequences for frames belonging to the same or different ACs to achieve downlink MU-MIMO. The duration of the EDCA TXOP is bounded by the TXOP limit of the primary AC. In addition, the aggregated MAC protocol data unit (A-MPDU) for at least one wireless terminal (e.g. wireless terminal 110) in each MU PPDU contains only MAC service data unit (MSDUs) from the primary AC.

In downlink MU-MIMO transmission, i.e., EDCA TXOP sharing, PPDU(s) belonging to secondary AC(s) may be transmitted simultaneously with the PPDU(s) of primary AC. The EDCAF of primary AC, as in single user transmission, shall invoke back-off procedure depending on the transmission results.

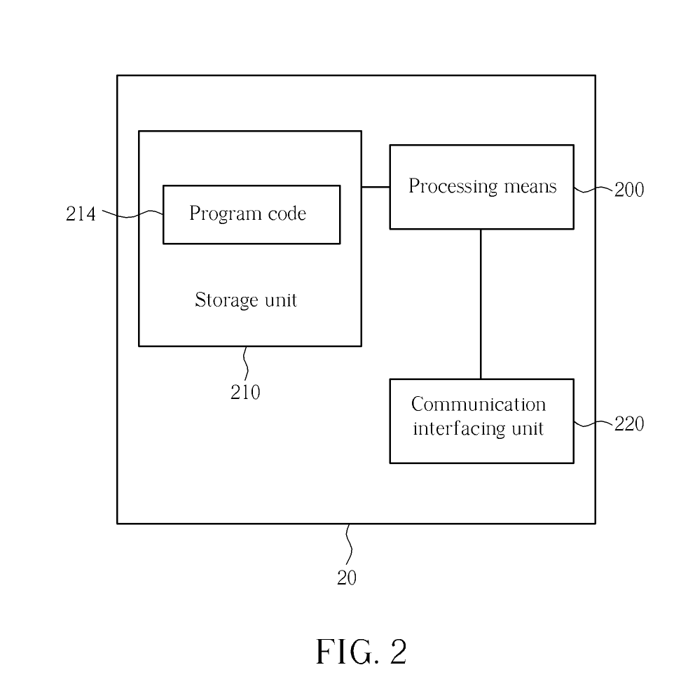

FIG. 2 illustrates a schematic diagram of a communication device 20 according to an example of the present invention. The communication device 20 maybe implementation of the wireless access point 100 and the wireless terminals 110, 112, 114 shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that can store a program code 214, for access by the processing means 200. Examples of the storage unit 210 include but are not limited to a subscriber identity module (SIM), read-only memory (ROM), flash memory, random-access memory (RAM), CD-ROMs, magnetic tape, hard disk, and optical data storage device. The communication interfacing unit 220 is preferably a radio transceiver and can exchange signals with the network 120 according to processing results of the processing means 200.

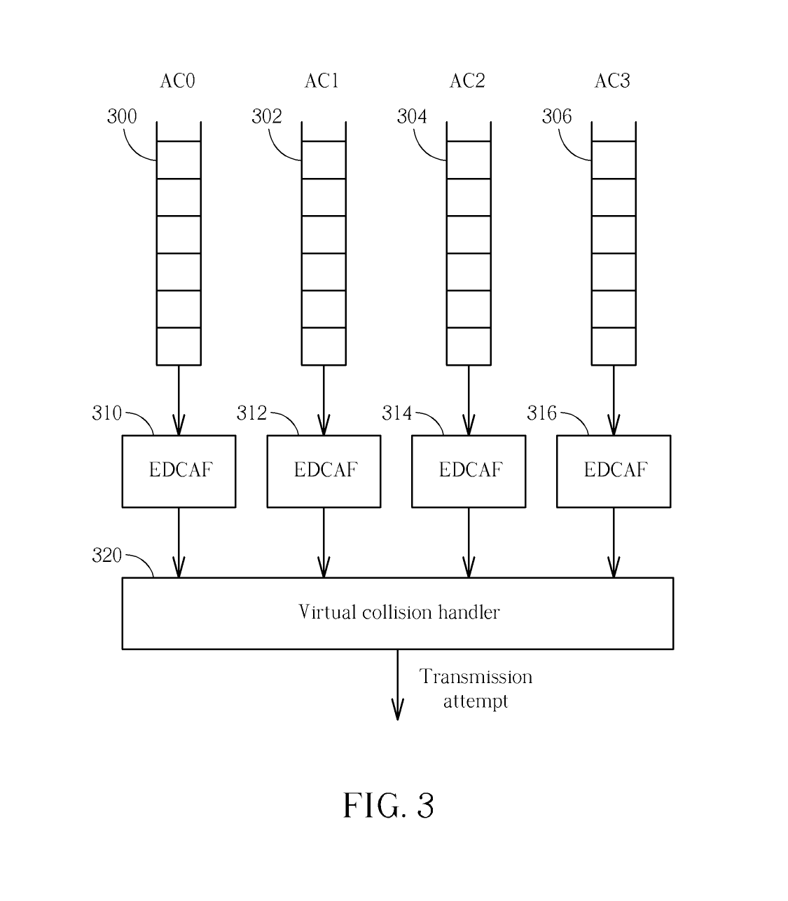

FIG. 3 illustrates a structure diagram of the wireless access point 100. The wireless access point 100 includes EDCA transmission queues 300, 302, 304, 306 assigned for AC0, AC1, AC2, AC3 respectively, EDCAF blocks 310, 312, 314, 316 corresponding to AC0, AC1, AC2, AC3 respectively, and a virtual collision handler 320. The queues 300, 302, 304, 306 are used for queuing MSDUs from upper layer. Each of AC1, AC1, AC2, and AC3 represents one of the four ACs specified in IEEE 802.11e (i.e. AC_VO, AC_VI, AC_BC and AC_BK). An MSDU is queued in one of the EDCA transmission queues 300, 302, 304, and 306, according to traffic type of the MSDU mapped to a specific AC. Each of the EDCAF blocks 310, 312, 314, and 316 is utilized for setting arbitration inter-frame space (AIFS), contention window and back-off timer. For example, the EDCAF block 310 is responsible for setting AIFS of AC0 (AIFS[AC0]), maximum contention window of AC0 (CWmax[AC0]), minimum contention window of AC0 (CWmin[AC0]), contention window of AC0 (CW[AC0]), and back-off timer of AC0 (BC[AC0]). Each AC has a corresponding AIFS and maintains its own back-off timer. The virtual collision handler 320 is utilized for coordinating collisions between the ACs AC0, AC1, AC2 and AC3. For example, assume that the priority of AC1 is higher than that of AC2, when a collision of AC1 and AC2 occurs, the virtual collision handler 320 selects AC1 to perform transmission first; that is, AC1 wins the EDCA TXOP to access the medium. In such a condition, if MU-MIMO is applicable, AC1 becomes the primary AC, while the other ACs (such as AC0, AC2 and AC3) participating and sharing the MU-MIMO transmissions become the secondary ACs.

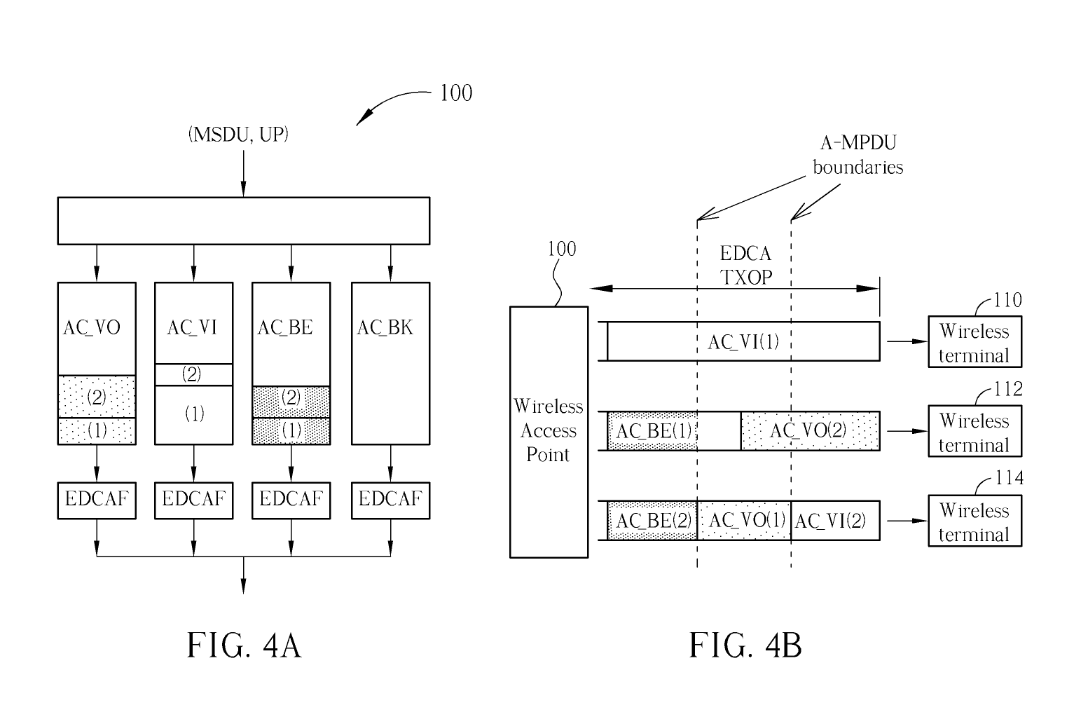

FIGS. 4A-4B illustrate diagrams of TXOP sharing. In FIG. 4A, the wireless access point 100 has four ACs: AC_VO, AC_VI, AC_BE, and AC_BK, where each AC has its own EDCAF. AC_VO, AC_VI, and AC_BE have two MAC service data unit (MSDU) frames respectively waiting to be transmitted, as MSDU frames AC_VO(1) and AC_VO(2) in the EDCA transmission queue of AC_VO, AC_VI(1) and AC_VI(2) in the EDCA transmission queue of AC_VI, and AC_BE(1) and AC_BE(2) in the EDCA transmission queue of AC_BE. In FIG. 4B, the MSDU frame AC_VI(1) is to be transmitted to the wireless terminal 110, AC_VO(2) and AC_BE(1) are to be transmitted to the wireless terminal 112, and AC_VI(2), AC_VO(1) and AC_BE(2) are to be transmitted to the wireless terminal 114. Assume that AC_VI is the primary AC, which means the EDCAF of AC_VI wins the EDCA TXOP for transmission and shares the TXOP with other ACs which are AC_VO and AC_BE in this example. The wireless access point 100 supports downlink MU-MIMO, such that the wireless access point 100 may transmit frames with different ACs to the wireless terminals 110, 112, 114 in the EDCA TXOP. There may be multiple frames transmitted during an EDCA TXOP. The duration of the period of the EDCA TXOP is determined according to the TXOP limit of the primary AC. The EDCAFs of the primary AC, AC_VI, and the secondary ACs, which are participating in the transmission during the EDCA TXOP (i.e. AC_VO and AC_BE), invoke back-off procedures and set the back-off timers after the end of the EDCA TXOP depending on the transmission results.

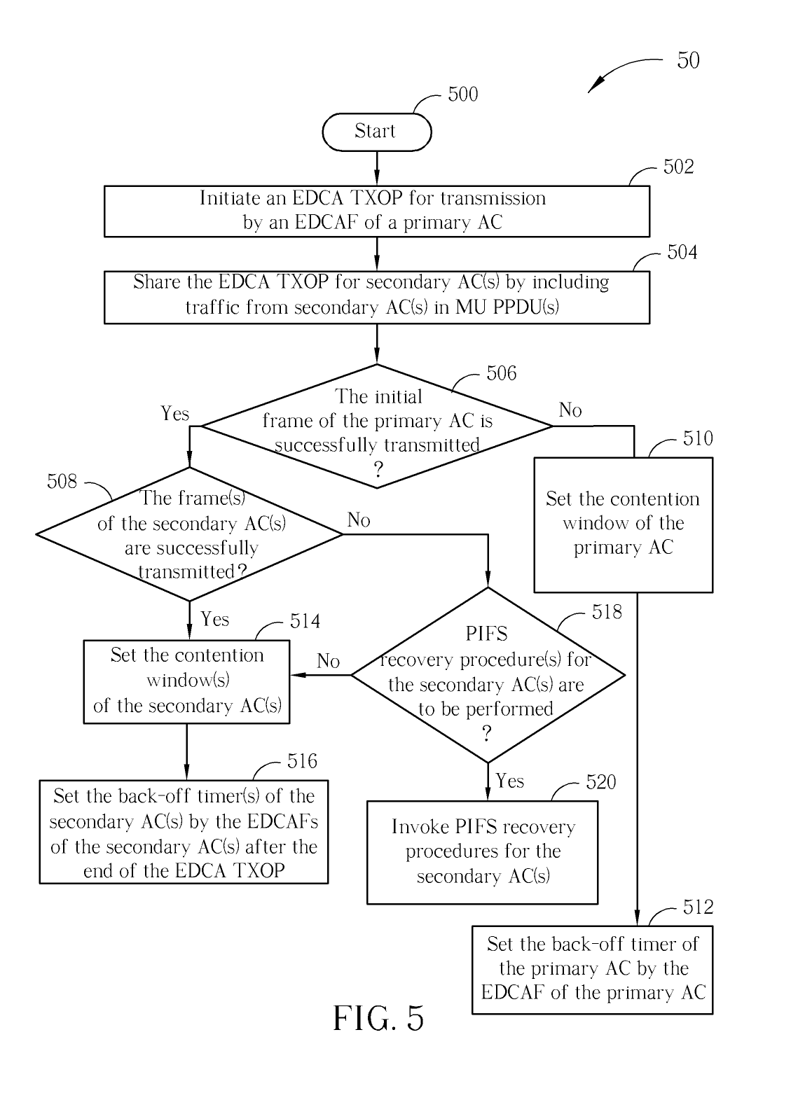

Please refer to FIG. 5, which is a flowchart of a back-off procedure setup process 50 according to an example of the present invention. The process 50 is performed in the wireless access point 100. The process 50 can be compiled into the program code 214 and includes the following steps:

Step 500: Start.

Step 502: Initiate an EDCA TXOP for transmission by an EDCAF of a primary AC.

Step 504: Share the EDCA TXOP for secondary AC(s) by including traffic from secondary AC(s) in MU PPDU(s).

Step 506: Determine whether the initial frame of the primary AC is successfully transmitted. If yes, go to Step 508; otherwise, go to Step 510.

Step 508: Determine whether the frame(s) of the secondary AC(s) are successfully transmitted. If yes, go to Step 514; otherwise, go to Step 518.

Step 510: Set the contention window of the primary AC.

Step 512: Set the back-off timer of the primary AC by the EDCAF of the primary AC.

Step 514: Set the contention window(s) of the secondary AC(s).

Step 516: Set the back-off timer(s) of the secondary AC(s) by the EDCAFs of the secondary AC(s) after the end of the EDCA TXOP.

Step 518: Determine whether to invoke PIFS recovery procedure(s) for the secondary AC(s). If yes, go to Step 520; otherwise, go to Step 514.

Step 520: Invoke the PIFS recovery procedures for the secondary AC(s).

The process 50 starts when the ACs compete for the EDCA TXOP for transmission. The AC that is granted the EDCA TXOP to initiate frame exchange sequence and shares the EDCA TXOP with other AC(s) is called the primary AC. The other AC(s) which participate in the EDCA TXOP are called secondary AC(s). If the initial frame of the primary AC of the EDCA TXOP is not successfully transmitted (Step 506), the EDCAF of the primary AC invokes a back-off procedure to set the contention window and the back-off timer of the primary AC (Step 510 and Step 512). The value of the back-off timer of the primary AC is selected within the range of the contention window of the primary AC. The workings of EDCAFs of the secondary ACs remain the same, e.g., the back-off timers of the secondary ACs are not changed.

Otherwise, if the initial frame of the primary AC of the EDCA TXOP is successfully transmitted, the transmission results of the secondary ACs should be determined before invoking back-off process (Step 508). If the frame(s) of the secondary AC(s) is/are successfully transmitted, the wireless access point 100 sets the contention window(s) of the secondary AC(s) (Step 514), and then the EDCAFs of the secondary AC(s) sets the back-off timers of the secondary AC(s) after the end of EDCA TXOP (Step 516). Otherwise, if the frame(s) of the secondary AC(s) is/are not successfully transmitted, the wireless access point 100 checks whether to perform the PIFS recovery procedure for the secondary AC(s). If the PIFS recovery procedure for the secondary AC(s) is determined, the wireless access point 100 invokes the PIFS recovery procedure for the secondary AC(s) (Step 518); otherwise, the wireless access point 100 sets the contention window(s) of the secondary AC(s), and then the EDCAFs of the secondary AC(s) invoke the back-off procedures for the secondary AC(s) after the end of EDCA TXOP. Note that PIFS recovery is an optional error-recovery method within the duration of a TXOP. After obtaining a TXOP, if there is a transmission failure and the carrier-sensing mechanism indicates that the medium is idle at the TxPIFS slot boundary, the corresponding channel access function may be allowed to retransmit the failed frame immediately without performing back-off procedure.

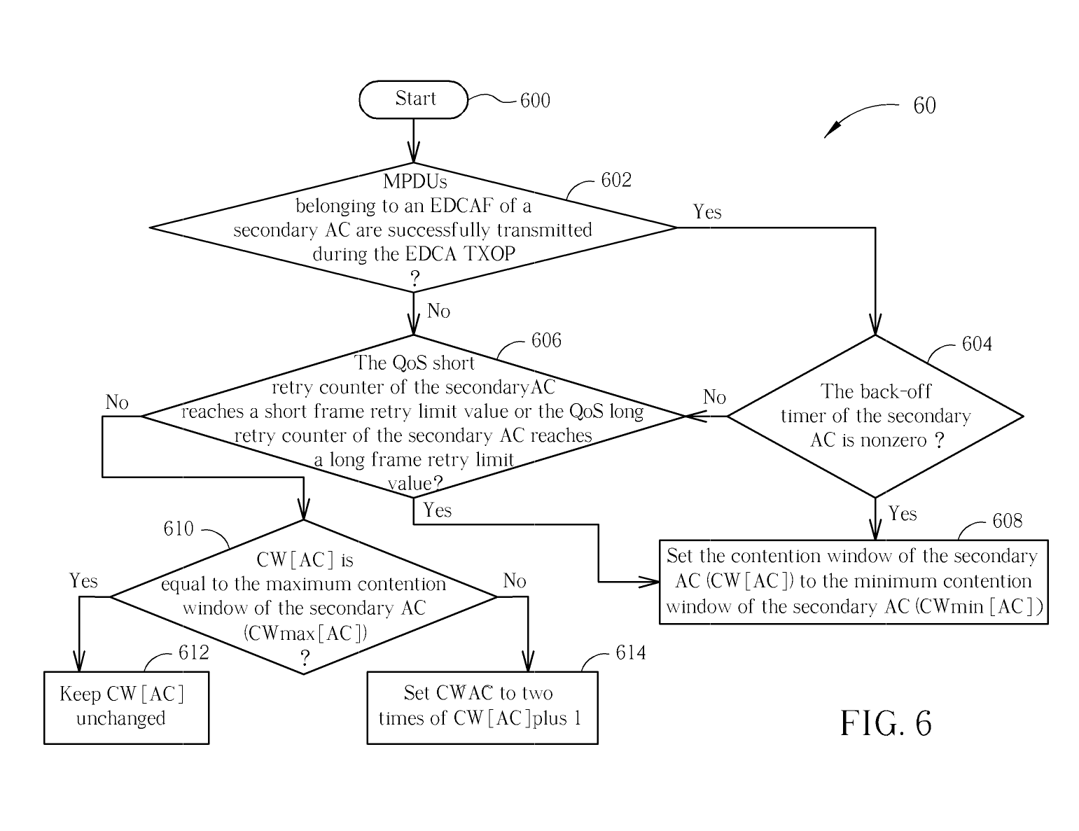

In detail, the contention window(s) of the secondary AC(s) and the back-off timer(s) of the secondary AC(s) may be set variously according to different conditions. Please refer to FIG. 6, which is a flowchart of a contention window setup process 60 according to an example of the present invention. The process 60 is performed in the wireless access point 100. The process 60 can be compiled into the program code 214 and includes the following steps:

Step 600: Start.

Step 602: Determine whether MPDUs belonging to an EDCAF of a secondary AC are successfully transmitted during the EDCA TXOP. If yes, go to Step 604; otherwise, go to Step 606.

Step 604: Determine whether the back-off timer of the secondary AC is nonzero. If yes, go to Step 608; otherwise, go to Step 606.

Step 606: Determine whether the QoS short retry counter of the secondary AC reaches a short frame retry limit value or the QoS long retry counter of the secondary AC reaches a long frame retry limit value. If yes, go to Step 608; otherwise, go to Step 610.

Step 608: Set the contention window of the secondary AC (CW[AC]) to the minimum contention window of the secondary AC (CWmin[AC]).

Step 610: Determine whether CW[AC] is equal to the maximum contention window of the secondary AC (CWmax[AC]). If yes, go to Step 612; otherwise, go to Step 614.

Step 612: Keep CW[AC] unchanged.

Step 614: Set CW[AC] to two times of CW[AC] plus 1.

Note that, the process 60 describes contention window setup only for one secondary AC for simplification. Since the secondary ACs are independent during the EDCA TXOP, the process 60 is applicable for each of the secondary ACs.

According to the process 60, when invoking a back-off procedure by the EDCAF of a secondary AC after the end of the EDCA TXOP, the wireless access point 100 first determines whether the MPDUs belonging to the EDCAF of the secondary AC are successfully transmitted during the EDCA TXOP (Step 602). If the MPDUs of the secondary AC are successfully transmitted, the wireless access point 100 checks the back-off timer of the secondary AC (Step 604). If the back-off timer is not zero, CW[AC] is set to CWmin[AC] (Step 608). If the back-off timer is zero, which means the EDCAF of the secondary AC experiences an internal collision with the EDCAF of the primary AC, and the priority of the secondary AC is lower than the primary AC, the wireless access point 100 checks the QoS short retry counter and the QoS long retry counter of the secondary AC (Step 606). If the QoS short retry counter reaches the short frame retry limit value (such as dot11ShortRetryLimit), or the QoS long retry counter reaches the long frame retry limit value (such as dot11LongRetryLimit), CW[AC] is set to CWmin[AC] (Step 608). The short frame retry limit value indicates the maximum number of transmission attempts of a frame, the length of which is less than or equal to the threshold parameter dot11RTSThreshold set in the wireless access point 100. The long frame retry limit value indicates the maximum number of transmission attempts of a frame, the length of which is greater than the threshold parameter dot11RTSThreshold. If the QoS short retry counter does not reach the short frame retry limit value, and the QoS long retry counter does not reach the long frame retry limit value, CW[AC] is then compared to CWmax[AC] (Step 610). If the CW[AC] is equal to CWmax[AC], CW[AC] remains unchanged (Step 612). Otherwise, if CW[AC] is less than CWmax[AC], CW[AC] is set to 2 times of CW[AC] plus 1 (Step 614).

If the MPDUs of the secondary AC are not all successfully transmitted, the wireless access point 100 checks the QoS short retry counter and the QoS long retry counter of the secondary AC. If the QoS short retry counter reaches the short frame retry limit value, or the QoS long retry counter reaches the long frame retry limit value, CW[AC] is reset to CWmin[AC]. If the QoS short retry counter does not reach the short frame retry limit value, and the QoS long retry counter does not reach the long frame retry limit value, CW[AC] is then compared to CWmax[AC]. If the CW[AC] is equal to CWmax[AC], CW[AC] remains unchanged. Otherwise, if CW[AC] is less than CWmax[AC], CW[AC] is set to two times of CW[AC] plus 1.

After the process 60, the EDCAF(s) of the secondary AC(s) sets the back-off timer(s) of the secondary AC(s) after the end of EDCA TXOP. The value of the back-off timer of the secondary AC is selected within a range of the contention window of the secondary AC. Specifically, the value(s) of the back-off timer(s) of the EDCAF(s) of the secondary AC(s) is/are respectively set to integer value(s) drawn randomly with a uniform distribution taking values within the range [0, CW[AC]] inclusively.

Alternatively, the contention window(s) and the value of the back-off timer(s) of the secondary AC(s) may keep unchanged after the end of the EDCA TXOP if the value(s) of the back-off timer(s) of the secondary AC(s) is/are not zero.

Alternatively, the contention window(s) of the secondary AC(s) may keep unchanged if the value(s) of the back-off timer(s) of the secondary AC(s) is/are zero. After the end of EDCA TXOP, the EDCAF(s) of the secondary AC(s) sets the back-off timer(s) of the secondary AC(s). The value of the back-off timer of the secondary AC is selected within a range of the contention window of the secondary AC. Specifically, the value(s) of the back-off timer(s) of the EDCAF(s) of the secondary AC(s) is/are respectively set to integer value(s) drawn randomly with a uniform distribution taking values within the range [0,CW[AC]] inclusively.

Note that, in the aforementioned FIGS. 1 and 4, PPDU frames with different ACs are transmitted to different destinations. The wireless access point may transmit PPDU frames with different ACs to the same destination, i.e., the same wireless terminal.

To sum up, according to the methods disclosed in the above, a wireless access point can set back-off timers of primary AC and secondary ACs involved in an EDCA TXOP, so as to maintain fair contention-based channel access between wireless terminals sharing the wireless medium.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of back-off procedure setup in a wireless communication system, comprising:
initiating an enhanced distributed channel access (EDCA) transmit opportunity (TXOP) for transmission by a primary access category (AC);
sharing the EDCA TXOP with at least a secondary AC by including traffics from the at least a secondary AC in one or more multi-user physical layer protocol data units (MU-PPDUs);
determining whether an initial frame of the primary AC is successfully transmitted;
determining whether one or more frames of one of the at least a secondary AC are successfully transmitted during the EDCA TXOP;
determining whether to invoke a point coordination function inter-frame space (PIFS) recovery procedure for the secondary AC if the one or more frames of the secondary AC are not successfully transmitted during the EDCA TXOP;
setting a contention window of the secondary AC by an enhanced distributed channel access function (EDCAF) of the secondary AC; and
setting a back-off timer of the secondary AC after the end of the EDCA TXOP.

2. The method of claim 1, wherein the step of setting the contention window of the secondary AC by the EDCAF of the secondary AC comprises:
determining whether one or more MAC protocol data units (MPDUs) belonging to the EDCAF of the secondary AC are successfully transmitted during the EDCA TXOP; and
determining whether a back-off timer of the secondary AC has a value of zero if the one or more MPDUs are successfully transmitted during the EDCA TXOP.

3. The method of claim 2, wherein the contention window of the secondary AC is set to a first value if the one or more MPDUs are successfully transmitted during the EDCA TXOP and the value of the back-off timer of the secondary AC is not zero.

4. The method of claim 2, wherein the step of setting the contention window of the secondary AC by the EDCAF of the secondary AC further comprises:
determining whether a quality of service (QoS) short retry counter of the secondary AC reaches a second value or a QoS long retry counter of the secondary AC reaches a third value, if one of the following condition is met:
(1) the one or more MPDUs are successfully transmitted during the EDCA TXOP and the value of the back-off timer of the corresponding secondary AC is zero; and
(2) at least one of the one or more MPDUs is not successfully transmitted during the EDCA TXOP; and
determining whether the contention window of the secondary AC is equal to a fourth value if the QoS short retry counter of the secondary AC does not reach the second value and the QoS long retry counter of the secondary AC does not reach the third value.

5. The method of claim 4, wherein the contention window of the secondary AC is set to a fifth value if the QoS short retry counter of the secondary AC reaches the second value or if the QoS long retry counter of the secondary AC reaches the third value.

6. The method of claim 4, wherein the contention window of the secondary AC is set to a sixth value if the QoS short retry counter of the secondary AC does not reach the second value, the QoS long retry counter of the secondary AC does not reach the third value, and the contention window of the secondary AC is not equal to the fourth value.

7. The method of claim 4, wherein the contention window of the secondary AC is left unchanged if the QoS short retry counter of the secondary AC does not reach the second value, the QoS long retry counter of the secondary AC does not reach the third value, and the contention window of the secondary AC is equal to the fourth value.

8. The method of claim 2, wherein the step of setting the back-off timer of the secondary AC after the end of the EDCA TXOP comprises:
setting the back-off timer of the secondary AC by an EDCAF of the secondary AC;
wherein the value of the back-off timer of the secondary AC is selected within a range of the contention window of the secondary AC.

9. The method of claim 3, wherein the first value is a minimum contention window of the secondary AC.

10. The method of claim 4, wherein the second value is a short frame retry limit value.

11. The method of claim 4, wherein the third value is a long frame retry limit value.

12. The method of claim 4, wherein the fourth value is a maximum contention window of the secondary AC.

13. The method of claim 5, wherein the fifth value is a minimum contention window of the secondary AC.

14. The method of claim 6, wherein the sixth value is two times of the contention window of the secondary AC plus 1.

15. The method of claim 1, wherein if the value of a back-off timer of the secondary AC is not zero, the contention window of the secondary AC and the value of the back-off timer of the secondary AC are left unchanged.

16. The method of claim 1, wherein if the back-off timer of the secondary AC has a value of zero, the contention window of the secondary AC is left unchanged; and after the end of EDCA TXOP, the EDCAF of the secondary AC sets the back-off timer of the secondary AC, wherein the value of the back-off timer of the secondary AC is selected within a range of the contention window of the secondary AC.

17. The method of claim 1, further comprising:
invoking the PIFS recovery procedure when the one or more frames of the secondary AC are not successfully transmitted during the EDCA TXOP and the PIFS recovery procedure for the secondary AC is determined to be invoked.

18. The method of claim 1, further comprising:
setting a contention window of the primary AC by an EDCAF of the primary AC if the initial frame of the primary AC is not successfully transmitted; and
setting a back-off timer of the primary AC;
wherein a value of the back-off timer of the primary AC is selected within a range of the contention window of the primary AC.
